(19) United States
(12) Patent Application Publication
(10) Pub. No.: US 2018/0218868 A1
(43) Pub. Date: Aug. 2, 2018

(54) IN-LINE BLADE FUSE SYSTEM

(71) Applicant: Continental Automotive Systems, Inc., Auburn Hills, MI (US)

(72) Inventors: Sergio Elias-Palacios, Rochester Hills, MI (US); Nicholas Hartley, Sterling Heights, MI (US); Francois Chauvin, Windsor (CA)

(21) Appl. No.: 15/420,339

(22) Filed: Jan. 31, 2017

(51) Int. Cl. H01H 85/02; H01H 85/20; H01R 13/04; H01R 12/70

(52) U.S. Cl. CPC H01H 85/0241; H01H 85/203; H01H 85/2045; H01H 2223/044; H01R 12/70; H01H 2085/0275; H01R 13/04

(57) ABSTRACT

A vertically-oriented blade fuse system requires less surface area on a printed circuit board, provides improved heat dissipation, is less expensive to manufacture and assemble and is more reliable. It comprises a fuse having two connection plates that extend away from each other in opposite directions. One of the plates is forced into a fork-shaped connector, which grabs both sides of the plate. The other connection plate is fit into a mating female connector. Multiple vertically-oriented fuses, laterally spaced from each, are connected to corresponding connection forks and female connectors inside a housing, which can be latched to a circuit board.

### BACKGROUND

As used herein, a fuse is an electrical safety device essentially comprising a strip of metal or wire, which melts and thus breaks an electric circuit when the amount of current passing through the wire causes the wire's temperature to increase to a temperature at which the wire melts. When the wire melts, it effectively disconnects a power source from a load. The wire's characteristics are thus selected to melt and break before the current flowing through the fuse wire exceeds a safe level for circuitry or other electrical devices “downstream” of the fuse.

Most prior art fuses are designed to fit into fuse receptacles that are arranged to be horizontal. A problem with mounting a fuse horizontally on a circuit board is that it takes up valuable circuit board space. The area or space required to accommodate a fuse on a densely packed printed circuit board often necessitates omitting the fuse device altogether or, locating it somewhere else, i.e., remotely, and connecting the circuit board to the remote fuse using a wiring harness. A fuse and connector that requires less area would be an improvement over the prior art.

### BRIEF DESCRIPTION OF THE FIGURES

FIG. 1 is an exploded view of one embodiment of a In-Line blade fuse system;

FIG. 2 is a perspective view of a preferred embodiment of a In-Line blade fuse system;

FIG. 3 is a perspective view of the bottom of a connector housing having several compartments, each of which is configured, i.e., sized and shaped, to receive and retain a fuse connector; and

FIG. 4 is an isometric or perspective view of a vertically-oriented In-Line blade fuse system assembled and attached to a printed circuit board.

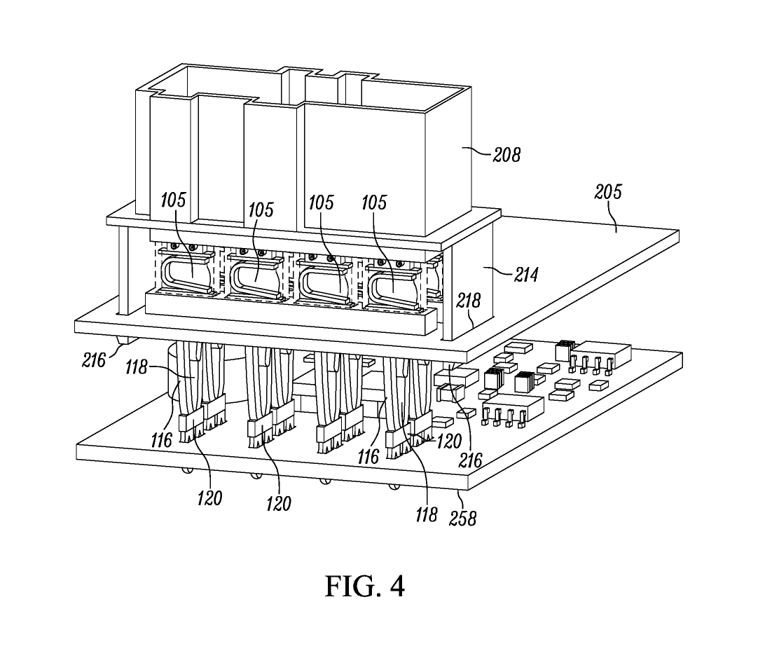

### DETAILED DESCRIPTION

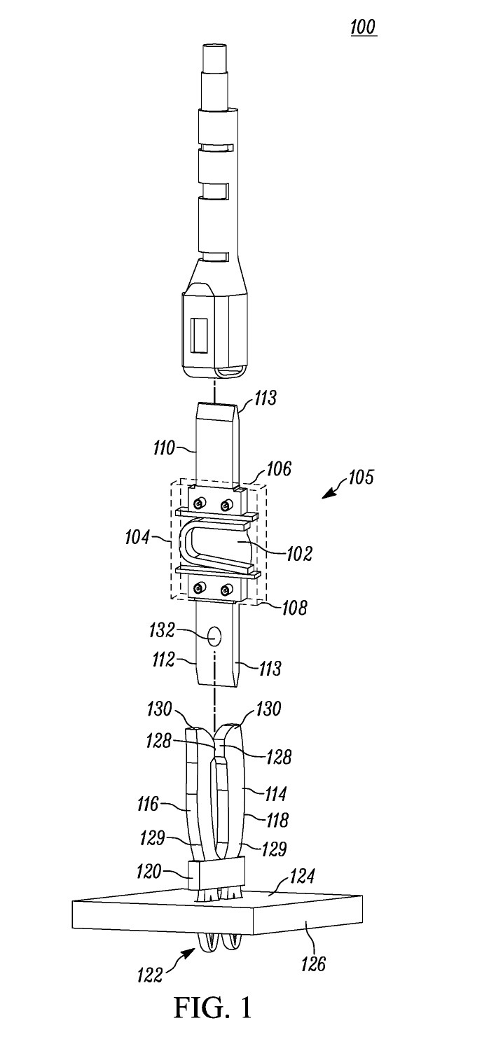

Referring now to FIG. 1, a first embodiment of a vertically-oriented In-Line blade fuse system 100 comprises a fusible link 102 located inside a fuse housing 104. The fuse housing 104, which is essentially shaped to resemble a parallelepiped, has first and second opposing ends 106 and 108. The housing 104 and the fusible link 102 it encloses comprise a fuse 105.

First and second terminal plates 110 and 112, which also resemble parallelepipeds but with tapered ends 113, extend away from the housing 104 in opposite directions (vertically, in FIG. 1) and are electrically connected to the fusible link 102 inside the housing 104. The terminal plates 110, 112 thus extend through the material from which the housing 104 is made.

A “fork” is generally known as an implement with two or more substantially parallel prongs that extend from a handle. In FIG. 1, a substantially fork-shaped connector 114, referred to hereinafter as a connection fork, has first and second, substantially parallel elongated tines 116 and 118. The tines 116, 118 are formed from and extend from a handle portion identified generally by reference numeral 120, the bottom end of which 122 extends through a hole 124 formed in a conventional circuit board 126. In the embodiment shown, the tines 116, 118 have small protuberances 128 at the distal ends 130 of the tines and which extend toward each other.

The connection fork 114 is stamped from thin sheet metal and is generally planar. When a terminal plate 112 is inserted between the tines, the tines 116, 118 are urged away from each other by the terminal plate 112.

Those of ordinary skill in the mechanical arts know that the term, “fit” is the general term used to signify or describe the range of tightness that may result from the application of a specific combination of allowances and tolerances in the design of mating parts. An interference fit, which is also known as a press fit or friction fit, is a fastening between two parts achieved by friction after the parts are pushed or forced together, rather than by any other means of fastening.

In FIG. 1, the shape and spacing between the tines 116, 118 and the thickness of the terminal plate 112 and the elasticity of the metal from which the tines 116, 118 are constructed, provides an interference fit between the tines and the protuberances and the terminal plate 112. The interference fit thus mechanically and electrically couples the fuse 105 and its fusible link 102 to the connection fork 114. The tines 116 and 118 thus expand and contract in opposite directions relative to each other and responsive to insertion and removal of a terminal plate into and out of the space between the tines, including the protuberances, if any.

Inasmuch as the tines are formed from a planar or substantially planar metal, they expand and contract in what is essentially a geometric plane. That plane, and the tines' expansion and contraction is in a direction substantially orthogonal to the surfaces of the terminal plates.

The hole 124 in the circuit board 126 is sized and shaped to receive the handle portion 120 of the connection fork and to also provide an interference between them. In a preferred embodiment, the handle portion 120 is also soldered to a conductive trace on the circuit board or inside the connection hole 124 providing an improved electrical and mechanical connection there between. The interference fit between the hole 124 and handle portion 120 holds the connection fork 114 substantially upright or vertical, relative to the circuit board such that the tines 116 and 118 are held vertical and orthogonal to the surface of the printed circuit board.

As mentioned above, the tines 116, 118 have a first end 129 proximate or near to the handle 120. They also have a second or distal end 130 situated as far away from the handle 120 as possible. The distal end 130 is considered herein as including the aforementioned protuberances 128.

As used herein, a detent is considered to be a device for positioning and holding one mechanical part in relation to another in a manner such that the devices can be released from each other by force applied to one of the parts. In one alternate embodiment, the terminal plates 112 are provided with either a hole or an indentation 132 sized and shaped to receive at least part of the protuberances 128 and thus provide a detent. The detent will of course help retain the terminal plate in the connection fork and will help maintain its vertical alignment as shown in FIG. 1.

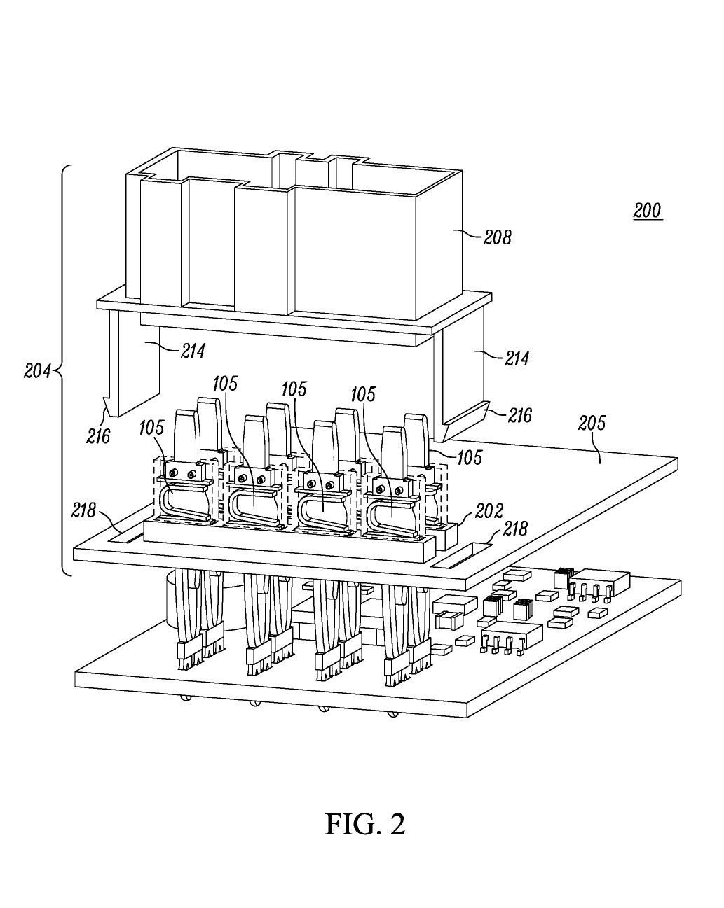

FIG. 2 shows an alternate and preferred embodiment of a vertically-oriented in-line blade fuse system 200. Several vertically-oriented blade fuses 105, constructed as described above and shown in FIG. 1, are mounted into corresponding holes 202 (not visible in FIG. 2) that extend through a two-part housing 204. The various blade fuses 105 shown in FIG. 2 are uniformly or evenly spaced apart from each other in both horizontal directions, i.e., the fuses 105 are laterally spaced evenly. Alternate embodiments of course include non-uniform or uneven spacing between such fuses.

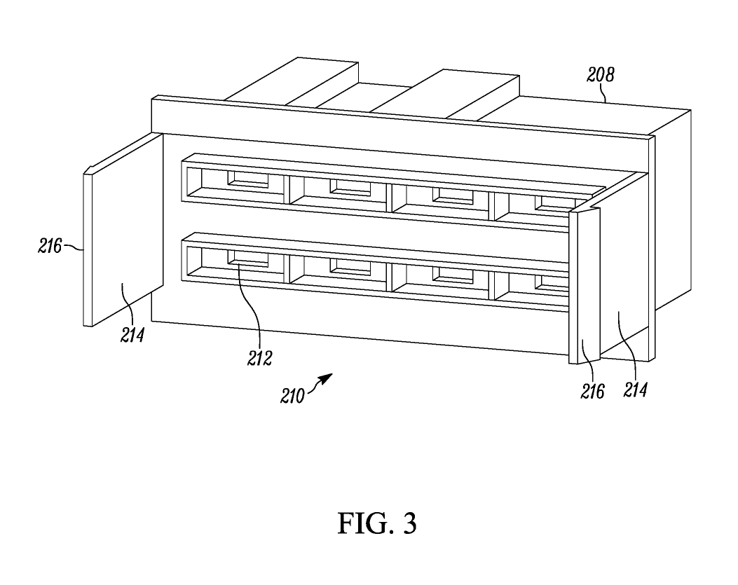

The embodiment 200 shown in FIG. 2 includes an upper connector housing portion 208, the bottom side of which is shown in FIG. 3 and identified by reference numeral 210.

As best seen in FIG. 3, the upper portion 208 of the connector housing 204 has several separate compartments 212, each of which is configured (sized and shaped) to receive and retain a female connector configured to fit over at least one of the planar terminal plates of a blade fuse 105 described above and depicted in FIG. 1.

Referring now to both FIG. 2 and FIG. 3, the upper portion 208 of the housing 204 is provided with two downwardly-extending clamping arms 214. A substantially pyramid-shaped barb 216 at the bottom end of each arm 214 is configured to fit into a mating slot 218 formed in a second or lower portion 205 of the main housing 204. The connecting arms 214 and connecting barbs 216 thus clamp the connector housing 208 over the blade fuses 105, holding any female connectors in place and in electrical contact with the terminal plates.

Those of ordinary skill in the art will recognize that the barbs 216 of the clamping arms 214 can instead be configured to engage a block of material attached directly to the top surface of the main housing 204.

Those of ordinary skill in the art should recognize that the in-line blade fuse system described above and depicted in the figures provides a mechanically and electrically reliable and repeatable interconnection using a compliant fuse fork. It also significantly reduces the surface area required on a printed circuit board below what is required of a prior art fuse. Multiple in-line blade fuse devices can be placed within the same footprint of a prior art horizontally-oriented fuse.

In addition to a reduced footprint or surface area use, the vertical blade fuse system allows air to circulate around fuses 105 and thus increases heat dissipation from them. The systems depicted above are far less expensive than a prior art fuse holder and mechanically and electrically more reliable.

The foregoing description is for purposes of illustration only. The true scope of the invention is set forth in the following claims.

1. An in-line-oriented blade fuse system comprising:
a fusible link having first and second opposing ends;
a housing, which encloses the fusible link;
first and second substantially planar terminal plates connected respectively to the first and second ends of the fusible link and extending through the housing in opposite directions;
a connection fork comprising first and second elongated and substantially planar, metal, tines, which are coupled to and extend away from a handle portion, the first elongated substantially planar metal tine lying in a first geometric plane, the second elongated substantially planar metal tine lying in a second geometric plane, the first and second geometric planes being substantially orthogonal to the first and second substantially planar terminal plates, the first and second elongated and substantially planar metal tines expanding and contracting in opposite directions relative to each other, the expansion and contraction of the tines being substantially in the first and second geometric planes and thus substantially orthogonal to the first and second substantially planar terminal plates and occurring responsive to insertion and removal of a terminal plate into and out of a space between the tines, the connection fork tines being sized, shaped and arranged to mechanically and electrically engage at least one of the first and second substantially planar terminal plates responsive to insertion of the substantially planar terminal plate between the tines.

2. The in-line-oriented blade fuse system of claim 1, wherein the first and second geometric planes are substantially coincident and wherein the first and second substantially planar metal tines have first and second ends, the first ends being in contact the first substantially planar metal terminal plate, wherein the first ends have protuberances that extend toward each other and contact opposite sides of the first substantially planar metal plate.

3. The in-line-oriented blade fuse system of claim 2, wherein at least one of the first and second substantially planar terminal plates has a hole, and wherein the protuberances extend at least part way into the hole.

4. (canceled)

5. The in-line-oriented blade fuse system of claim 3, further comprising a main housing, which is sized, shaped and arranged to receive said handle portion of the connection fork, the handle portion and hole being configured to maintain the connection fork substantially upright relative to the main housing such that the substantially planar metal tines are held substantially in-line with each other.

6. The in-line-oriented blade fuse system of claim 5, wherein the substantially planar metal tines have a second end proximate to the handle and a first distal end, which is away from the handle.

7. (canceled)

8. (canceled)

9. (canceled)

10. (canceled)

11. (canceled)

12. (canceled)

13. (canceled)

14. (canceled)
